(19) United States
(12) Patent Application Publication
(10) Pub. No.: US 2023/0247231 A1
(43) Pub. Date: Aug. 3, 2023

(54) APPARATUS AND METHOD FOR EVENT PARTICIPATION BY SPECTATORS

(71) Applicants: David COHEN, Herzliya (IL); Gadi GRAUS, Tel-Aviv (IL)

(72) Inventors: David COHEN, Herzliya (IL); Gadi GRAUS, Tel-Aviv (IL)

(21) Appl. No.: 18/009,729

(22) PCT Filed: Jun. 10, 2021
(86) PCT No.: PCT/IL2021/050707

§ 371 Date: Dec. 11, 2022

(30) Foreign Application Priority Data
Jun. 11, 2020 (IL) 275313
Jul. 16, 2020 (IL) 276124

(51) Int. Cl. H04N 21/218; H04N 23/66; H04N 23/695; H04N 21/4788

(52) U.S. Cl. CPC H04N 21/21805; H04N 23/66; H04N 23/695; H04N 21/4788

(57) ABSTRACT

An artificial live audience system provides a live spectator experience to player and spectator participants for an event at a location such as a stadium, theater, arena or the like, having a stage area and a seating area, when spectator participants are remotely connected to the event, the system comprising cameras at locations around the seating area to capture views of the stage area and send respective views to respective spectators; a plurality of loudspeakers around the seating area, each playing sounds gathered from a grouping of the spectators; and one or more microphones to obtain sounds from the event location, the sounds being sent to each spectator, thereby to provide both the players and the remote spectators with the live spectator experience.

### RELATED APPLICATIONS

The present application claims priority from Israel Patent Application No. 275313 filed Jun. 11, 2020 and from Israel Application No. 276124 filed Jul. 16, 2020.

### TECHNICAL FIELD

The present disclosed subject matter relates to participation in events by spectators and more particularly, the present disclosed subject matter relates to providing both the venue of an event and remotely located spectators with the experience of being a live event.

### BACKGROUND

The outbreak of the novel coronavirus, which as of the start of Jul. 2020 has killed more than half a million people globally, has led to the cancellation or postponement of sporting events, concerts, theaters, and other social events across the world. The most significant one that was due to take place in Japan this summer was the Tokyo 2020 Olympics.

Most professional sports leagues around the world and the international tournament have been either postponed or canceled, the same goes for all kinds of concerts, shows, and practically any event involving audience gathering.

The enforcement of social distancing measures around the world, brought in to limit the spread of coronavirus, has rendered crowd gathering impossible for the time being. So far, the most acceptable solution throughout the world is to hold the events without a crowd, and stream sport, entertainment and other events to people over the media. Yet, watching a sporting event, or an entertainment show or other social gatherings, such as a wedding or a religious ceremony from the comfort of one's own home diminishes the experience for which the event was intended, and furthermore diminishes the scope of the event itself. That is to say, players and performers do better with the feedback of an audience.

### SUMMARY OF THE INVENTION

The present embodiments may provide an experience in which the presence of the crowd is simulated at the event and the presence of the event is simulated to the remote spectators.

In accordance with an aspect of the present invention there is provided an artificial live audience system for providing a live spectator experience to player and spectator participants for an event at an event location being a stadium, theater, arena or the like, having a stage area and a seating area, when spectator participants are remotely connected to the event, the system comprising:

a plurality of cameras at locations around the seating area to capture views of the stage area and send respective views to respective spectators;
a plurality of loudspeakers around the seating area, each configured to play sounds gathered from a grouping of the spectators; and
one or more microphones located at the event location, and configured to obtain sounds from the event location, the sounds being sent to each spectator, thereby to provide both the players and the remote spectators with the live spectator experience.

The system may comprise at least one communication unit configured to communicate between the event location and respective remotely located spectators, the communication comprising video images and/or sound from the event location to the spectators, and sound from the spectators to the event location.

In an embodiment, the spectators are grouped with respective cameras and respective loudspeakers, wherein the sound from the spectators to the event location comprises sound at each loudspeaker amalgamated from a respective group.

In an embodiment, the spectators are grouped according to an association with seats of respective spectators, such that each group is formed from spectators associated with a contiguous block of seats. The camera may have pan, zoom, and tilt capabilities, and respective spectators may be given control privileges to remotely control the pan, zoom, and tilt capabilities of the camera.

In an embodiment, the at least one microphone comprises a plurality of microphones, each sensing the sound and voices in a vicinity of a respective camera. The microphones may be directional microphones.

Any given seat in the seating area may be associated with just one or with a plurality of spectators since it is just a location and no-one is actually sitting there.

The spectators may be grouped to form groups, and the communication unit may provide communication ability between spectators in a given group. Say spectators who normally sit near each other or anyone in the group may be able to share images or chat or talk to each other.

Grouping may be according to an association with seats of respective spectators, such that each group is formed from spectators associated with a contiguous block of seats, the communication thereby being enabled between spectators of neighbouring seats.

Embodiments may comprise a seat allocation unit for allocating seats to users according to different areas and categories of seats and/or according to respective accompanying privileges, the privileges including projection privileges for projecting the self or an avatar onto the venue, camera operating privileges, camera use privileges for obtaining views from different cameras and so on.

According to a second aspect of the present invention there is provided an artificial live audience system for providing a live spectator experience to player and spectator participants for a virtual event, when spectator participants are remotely connected to a virtual event, the system comprising:

a plurality of virtual cameras at locations around the seating area generating views of a virtual stage and send respective views to respective spectators;
a plurality of virtual loudspeakers around the seating area, each configured to define a spread of sounds to be experienced at the virtual event from the spectators; and
one or more virtual microphones configured to virtually obtain sounds as would be experienced in a real location, the sounds being sent to each spectator, thereby to provide a live spectator experience from the virtual event.

Unless otherwise defined, all technical and scientific terms used herein have the same meaning as commonly understood by one of ordinary skill in the art to which this disclosed subject matter belongs. Although methods and materials similar or equivalent to those described herein can be used in the practice or testing of the present disclosed subject matter, suitable methods and materials are described below. In case of conflict, the specification, including definitions, will control. In addition, the materials, methods, and examples are illustrative only and not intended to be limiting.

### BRIEF DESCRIPTION OF THE SEVERAL VIEWS OF THE DRAWINGS

Some embodiments of the disclosed subject matter described, by way of example only, with reference to the accompanying drawings. With specific reference now to the drawings in detail, it is stressed that the particulars shown are by way of example and for purposes of illustrative discussion of the preferred embodiments of the present disclosed subject matter only, and are presented in the cause of providing what is believed to be the most useful and readily understood description of the principles and conceptual aspects of the disclosed subject matter. In this regard, no attempt is made to show structural details of the disclosed subject matter in more detail than is necessary for a fundamental understanding of the disclosed subject matter, the description taken with the drawings making apparent to those skilled in the art how the several forms of the disclosed subject matter may be embodied in practice.

In the drawings:

FIG. 1 illustrates an arena layout for a real or virtual arena, in accordance with some exemplary embodiments of the disclosed subject matter;

FIG. 2 illustrates a section layout of the real or virtual arena of FIG. 1, in accordance with some exemplary embodiments of the disclosed subject matter;

FIG. 3 illustrates a participant/subscriber display, in accordance with some exemplary embodiments of the disclosed subject matter; and

FIG. 4 shows a crowd system, in accordance with some exemplary embodiments of the disclosed subject matter;

FIG. 5 shows a flowchart diagram of a an initiation method of the crowd system in accordance with some exemplary embodiments of the disclosed subject matter; and

FIG. 6 is a simplified flow diagram illustrating use of the crowd system in accordance with embodiments of the present invention.

### DETAILED DESCRIPTION

Before explaining at least one embodiment of the disclosed subject matter in detail, it is to be understood that the disclosed subject matter is not limited in its application to the details of construction and the arrangement of the components set forth in the following description or illustrated in the drawings. The disclosed subject matter is capable of other embodiments or of being practiced or carried out in various ways. Also, it is to be understood that the phraseology and terminology employed herein is for the purpose of description and should not be regarded as limiting. The drawings are generally not to scale. For clarity, non-essential elements were omitted from some of the drawings.

It is an aspect of the present subject matter to provide an artificial live audience system for providing a live spectator experience to player and spectator participants for an event at an event location being a stadium, theater, arena or the like, hereinafter the venue, having a stage area and a seating area, when spectator participants are remotely connected to the event. There is provided a spectator end system which displays the event to the spectator, or complements an existing system that displays the event to the spectator, and captures the spectator's vocal reactions and possibly visual reactions.

At the venue itself, cameras may capture the event and loudspeakers may play the sound captured from the various spectators. One or more microphones may capture the sound at the event, which may include sound as received from the various spectators. In embodiments, images of the spectators may be projected onto the seats or seating area. In an embodiment, groups may be formed of the spectators, so that each group has a sound channel. An individual group channel may be played on a dedicated speaker that is located in the seating area where the particular spectators have designated seats, and the spectators may be grouped together according to allocated seats. In an embodiment, spectators in a group may be able to chat or send messages or voice to each other so as to give something of the community experience of watching the event. Spectators may for example be able to send an image of a trumpet to encourage their friends to make lots of noise.

A server, which may be dedicated, or may be a virtual server allocated on the cloud, may communicate between the venue and the spectators, say streaming the video images and the sound to the group of spectators and in the opposite direction streaming the sound-out which comprises voice captured at each spectator. The server may control the streaming process and other aspects of the embodiments such as group management or controlling cameras or allocating privileges to different users.

It is noted that the spectator groups may be of any desired size. A VIP spectator may be allocated a group of one. Other groups may be based on different kinds of seats at the venue, including stalls, galleries, front row seats, etc.

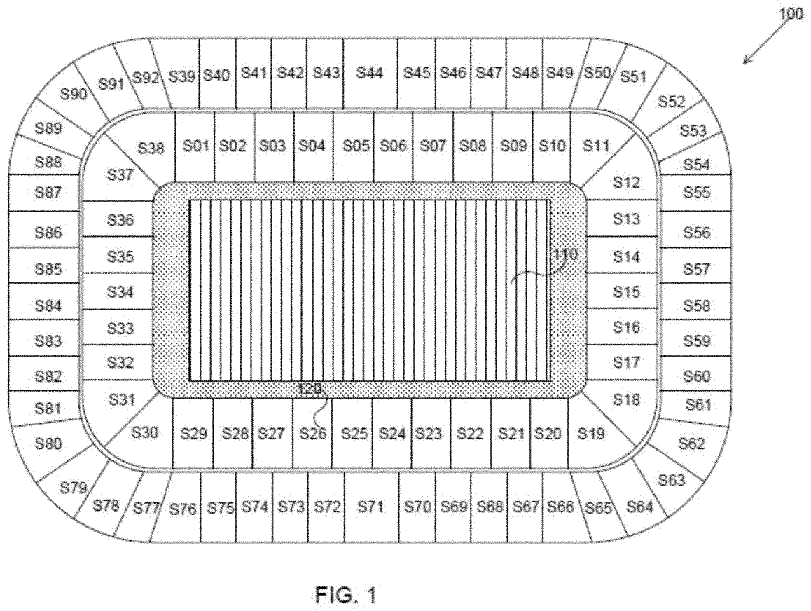

Referring now to FIG. 1 illustrating an arena layout, in accordance with some exemplary embodiments of the disclosed subject matter. The arena 100 can be a sport arena; a stadium; a concert-hall; an amphitheater; a theater; an athletic-field; a coliseum; an auditorium; an opera house; and any combination thereof, or the like and may particularly include a virtual arena or stage in which one or more persons interact on an artificially generated stage layout. In some cases the persons interacting may not be located together at all and in other cases the persons interacting may be located together but not on the background presented to the spectators.

In some exemplary embodiments, the arena 100 can be an outdoor arena or an indoor arena that comprises a stage 110 and a plurality of seats that are arranged in sections, such as section 120. It should be noted that each section 120 comprises a plurality of seats, where each seat is labeled for seating one or more designated spectators (participants). In the example depicted in FIG. 1, there are a total of 92 sections, however, it should be noted that arena 100 may comprise any number of sections that may be arranged in different layouts, such as for example a layout suitable for an auditorium, a concert hall, or the like, and galleries, stalls and boxes may be available at different levels. Furthermore, each section may have a different number of seats, thus each section may compromise a different number of participants.

In some exemplary embodiments, stage 110 may be football field; a baseball field; a soccer pitch; a hockey rink; a basketball court; a tennis court; a rugby field; a concert stage; an opera stage; a wedding ballroom; a church podium; and any combination thereof, or the like.

Stage 110 is a space on which concerts, shows, sports competitions, social functions or any form of activity that interests the audience take place.

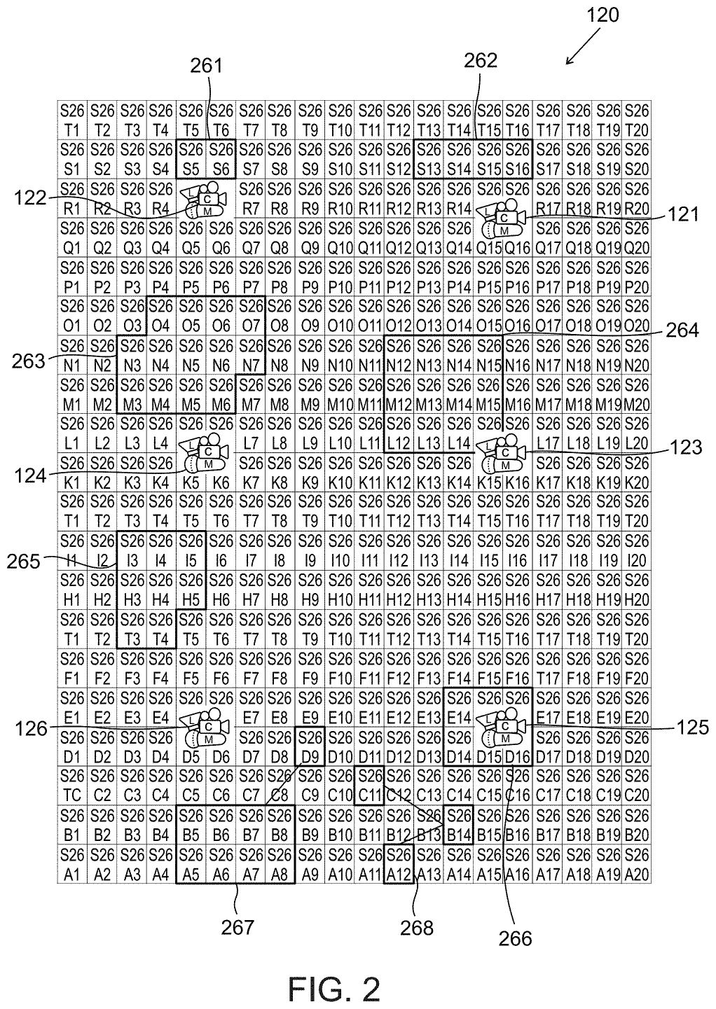

Referring now to FIG. 2 there is shown a section, in accordance with some exemplary embodiments of the disclosed subject matter. Section 120 as depicted in FIG. 2 is an example of one possible layout that any one of the sections may take. It should be noted that a section does not have to adhere to any specific geometric layout although it may usually contain contiguous seats. In some exemplary embodiments, the section 120 can be formed of a plurality of rows, each having a plurality of seats, wherein each seat may be labeled, e.g. S26A12=seat 12 of row A of section 26, for seating one or more designated participants, there being no need to limit one spectator to one seat as for a live audience. As noted above, each section may have a different number of seats, and a different number of participants.

In some exemplary embodiments, each section may have at least one microphone, at least one speaker, and at least one camera. The camera may have pan, zoom, and tilt (PZT) capabilities. In the example depicted in FIG. 2 there are six devices (121-126) which may be cameras, loudspeakers microphones or combinations thereof, however, it should be noted that each section may have any number of cameras or none at all, as the system may be designed to work with other services that live-stream the event. It will be appreciated that a large amount of cameras per section may enhance the spectator/participant experience by providing a view from as near as possible to his/her own familiar seat, say in the case of season ticket holders to sporting events, who tend to have their own seats.

In some exemplary embodiments, each participant of a plurality of participants is assigned with a seat, i.e. tangible seat, however, the participant doesn't physically occupy the seat. Instead, the participant virtually occupies the seat from his/her residence by means of a computerized device, such as a computer, a smart TV, a smartphone, a notepad, and any combination thereof, or the like.

In some exemplary embodiments of the disclosed subject matter, each participant may subscribe say via a service provider, operating the crowd simulation system of the present disclosure, for obtaining a seat for his/her choice of event. As with any real sporting or entertainment event, the subscription may have costs or conditions that vary according to the seat location or type. Thus there may be stalls, galleries, box seats, VIP seats, front row seats and the like, all allocated under different conditions. In addition, there may be differential access to cameras and views of the ground, and as will be explained below, different projection privileges for spectators to project themselves onto the ground.

In some exemplary embodiments, groups are formed of spectators. The groups may include spectators from contiguous seats so that spectators who know each other may share a group. Groups may also be formed from other spectators if they know each other even if not sitting near each other if desired, so that at least two socially related participants/subscribers can form a group that allows them (among other capabilities) to chat with each other, and share voice and images.

Each group, such as for example groups 261-268, is comprised of a plurality of seats, i.e. participants, that are virtually seated close to each other; although as mentioned, groups may alternatively be formed from distanced seats, for example groups 267 and 268. Furthermore, groups composed of seats from different sections may also be allowed. In the example in FIG. 2, only eight groups are depicted for the sake of simplifying the description, however, the number of groups per section in particular and the arena, in general, is practically unlimited in view of allowing group overlapping.

In some exemplary embodiments, each group is associated with one or more loudspeakers. For example, group 261 may be associated with loudspeaker 122; group 262 may be associated with loudspeaker 121; group 263 can be associated with loudspeaker 124; group 264 may be associated with loudspeaker 123; group 265 may be associated with loudspeakers 124 and 126; group 266 may be associated with loudspeaker 125; group 267 may be associated with loudspeaker 126 and group 268 may be associated with loudspeakers 126 and 125.

In some exemplary embodiments, each loudspeaker may be mounted on a stand, thus positioning the loudspeaker at a height approximately equal to the height of a sitting person. In some exemplary embodiments, a participant of a group can remotely control the pan, zoom and tilt of the camera of that the group is associated with. In some exemplary embodiments, the at least one microphone associated with the group is set to sense the sound and voices in the vicinity of the loudspeaker. In some exemplary embodiments, the speaker is set to play sounds picked by the microphone as well as the sounds and voices of the participants of the group the microphone is associated with. In another embodiment, microphones are provided for the ground as a whole and not for each group. Multiple microphones may be used to obtain a stereo or surround-sound effect.

In an embodiment, instead of gathering sound entirely from a microphone, it is possible to obtain the sound channels of the surrounding loudspeakers and mix them into a return channel for the group based on a delay based say on the distance of the surrounding loudspeaker, thus mixing an artificial version of the acoustics of the venue.

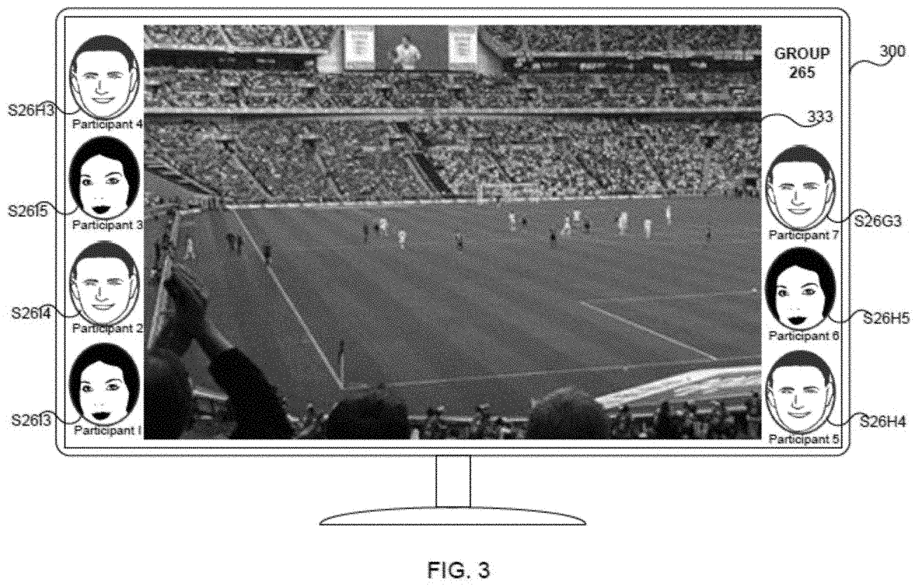

Referring now to FIG. 3 illustrating a spectator terminal including a terminal device 300, in accordance with some exemplary embodiments of the disclosed subject matter. The terminal device 300 may be part of any kind of user terminal device including a smart-TV, a laptop computer, a tablet-PC, a smartphone, a monitor supported by a computer, and any combination thereof, or the like.

In some exemplary embodiments, the terminal device 300 further comprises integrated speakers or connectors that enable the participant to connect the terminal device 300 to an external audio system. Additionally, or alternatively, the terminal device 300 comprises an operating system; such as Windows, Android, Linux MacOS; that manages the terminal device 300 hardware, software resources, application programs, and any combination thereof, or the like.

In some exemplary embodiments, a memory (not shown) of the terminal device 300 comprises an application program configured to perform executions required for implementing and activating the streaming and sound feedback system and method for crowd simulation of the present disclosure. Additionally, or alternatively, the application is adapted to utilize input/output capabilities (I/O); such as display screen, mouse keyboard, touch screen, camera, speakers, internet connection, handheld remote control, or the like; of the terminal device 300. In some exemplary embodiments, the I/O coupled with a user's interface (UI) of the application is used for online registering and authenticating the subscriber with a server (to be described in detail further below) of the augmented reality system.

In some exemplary embodiments, the I/O of the terminal device 300 may be used for playing synthesized sounds incorporating voices of other participants of the group that was discussed in relation to FIG. 2, with sounds captured by the microphone that the group is associated with. In some exemplary embodiments, the I/O of the terminal device 300 may be used for displaying, on viewing area 333, video-images of the live public event and video-images of the group's participants, e.g. participants S26I3, S26I4, S26I5, S26H3, S26H4, S26H5, S26G3, who establish the group. It should be noted that the UI provides the subscriber with an option of adding/removing participant images from his/her screen and arranging their location on the display. It should also be noted that the sounds, voices and all video images are streamed to the terminal device 300 of each subscriber are streamed by the server over the internet network.

In some exemplary embodiments, a group participant having control privileges may use the UI to determine which of a choice of video streams may be displayed in the viewing area 333. For example, video captured by the camera that the group is associated with; a different camera, or even splitting the viewing area 333 to incorporate a plurality of cameras. Additionally, or alternatively, the participant may elect to display on the viewing area 333 a television broadcast of the public event or a stream from another source.

In the case where the group is formed from contiguous seats in an area of the venue, the associated camera may be situated within the arena in the vicinity of the actual seats the group is assigned to.

The UI may further allow a chat window to be displayed on the terminal device 300 of the participants that are allowed to chat with each other during the event.

Furthermore, the UI allows each subscriber (participant in the group) to activate the camera and the microphone of his/her terminal device 300 to share voice and images with one or more of the other participants of the group.

It should be noted that for the sake of simplifying the description of FIG. 3 (above), the description has been given as an example, from a perspective of participant S26G4 of group 265, as shown in FIG. 2 that uses the terminal device 300, hence eliminating the self-image that is the image of participant S26G4 from the screen. Yet, each participant may have the option of presenting his/her own video-image on his/her display. Each participant may use the same functionalities as described for participant S26G4.

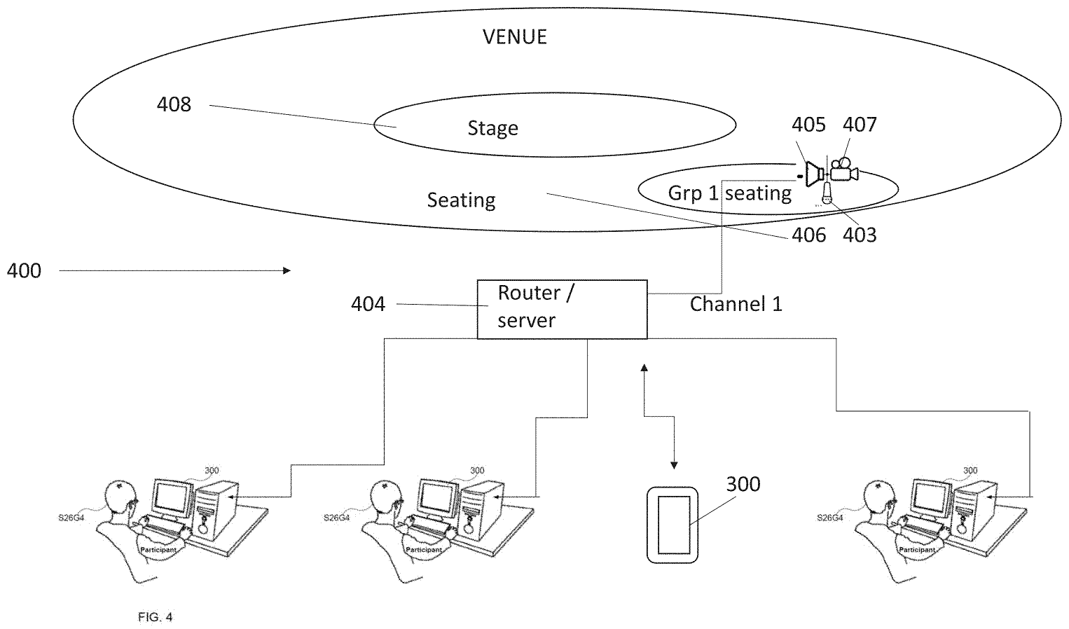

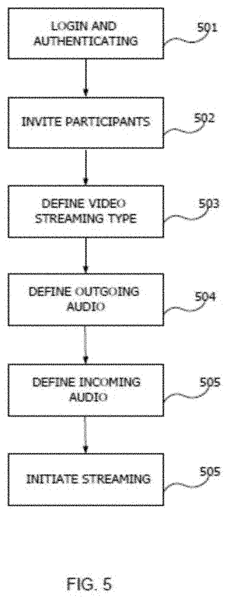

Referring now to FIG. 4, there is shown a crowd and live event system, in accordance with some exemplary embodiments of the disclosed subject matter. A system 400 can be a computerized system adapted to perform methods such as depicted in FIG. 5. In some exemplary embodiments, system 400 comprises at least one router or server 404, which may be router or a server, including a dedicated server or a cloud based server or virtual server, deployed in or connected to the venue 406. If connected to, then the router may be at a remote location and may comprise a collection of processing devices and services, such as the Amazon AWS cloud-computing platform. In some exemplary embodiments, server 404 may incorporate a video sub-server, a sound sub-server, an authentication server, payment gateway, routers, and any combination thereof, or the like that are adapted to perform methods such as depicted in FIG. 5. Additionally, or alternatively, server 404 may be configured to communicate, over the Internet, using protocols such as TCP/IP, with a plurality of spectators such as participant S26G4.

In some exemplary embodiments, the server or router 404 comprises a central processing unit (CPU) (not shown) which may be based on a microprocessor, an electronic circuit implemented as firmware written for or ported to a specific processor such as digital signal processor, or may be implemented as hardware or configurable hardware such as field-programmable gate array, or application-specific integrated circuit. The CPU may be utilized to perform computations required by system 400 and any of its subcomponents.

In some exemplary embodiments of the disclosed subject matter, server 404 may comprise an Input/output (I/O) module (not shown). Server 404 may utilize the I/O module as an interface to transmit and/or receive information and instructions between system 400 central devices, external I/O devices, such as microphones, loudspeakers, screens, projectors and the like, and the Internet.

In some exemplary embodiments, controller 401 can comprise a memory unit (not shown), which may be persistent or volatile. For example, flash disk, a random-access memory, a memory chip, an optical storage device; a magnetic hard disk, or the like. In some exemplary embodiments, the memory unit retains program code to activate the CPU to perform acts associated with controlling the augmented reality system with any of the method steps as will be shown in FIG. 5. The components detailed above can be implemented as one or more sets of interrelated computer instructions, executed for example by the CPU, server 404 or by another processor. The components may be arranged as one or more executable files, dynamic libraries, static libraries, methods, functions, services, or the like, programmed in any programming language and under any computing environment.

In some exemplary embodiments, system 400 comprises a plurality of microphones 403, at least one loudspeaker 405, and at least one camera 407, preferably a PZT camera that are all connected to router 404 using any suitable connection such as Ethernet or other cable connection or Bluetooth™ or Wi-Fi.

In some exemplary embodiments, server 404 may include a controller to serve as a gateway, having routing capabilities that aggregates the Ethernet connections from all the terminals. Each terminal is a network element having a unique identifying IP address, wherein all the terminals form a local area network (LAN) managed by the server or router 404 or a dedicated controller.

In some exemplary embodiments, some of the external device such as the camera, microphone and possibly the speaker, include a network interface circuit that manages communication with the server 404. The communication may comprise uploading from the terminal to the server data associated with a sound signal (sound-in data) captured by the microphone, and data associated with a video signal (video data), acquired by the camera. Additionally, or alternatively, the controller may communicate data associated with controlling the PZT functionality (control data) of the camera as well as streaming sound-out data to be played by the speaker.

In some exemplary embodiments, the controller 401 may further comprise a wide area network (WAN), for example a plurality of DSL connections, at least one fiberoptic connection, at least one E1 or T1 trunks. It should be noted that the WAN connection can be utilized by the controller for communicating with the server 404 over the internet.

In some exemplary embodiments, controller 401 routes sound-in data and video data to the server 404 via the WAN or other available means. Additionally, or alternatively, the controller 401 routs to the terminals control data and sound-out obtained from the server via the WAN.

In some exemplary embodiments, the server 404 may video stream video data of at least one camera that is associated with a specific group, to the terminal device 300 of all the participants of that group. Additionally, or alternatively, the server may embed to the video stream, the video-images of the group's participants.

In some exemplary embodiments, the server 404 may provide streaming audio to the devices 300 of all participants of a group, wherein the streamed audio is a synthesized composition of the group participants' voices and audio data from the venue. It should be noted that the server may subtract from each participant's streamed audio his/her own voices so as to avoid feedback issues, or may introduce delay into the system.

In some exemplary embodiments, the server 404 may stream a synthesized composition of group participants' voices (audio-out) to the corresponding loudspeaker. The audio-out playing by the speaker may involve chopping, alternating, delay or similar techniques for avoiding echo or feedback issues. The audio-out played by the speakers 405 at the venue is intended to be heard by players, athletes, singers, or any other group of people on stage 408 and thus to give the impression that an audience is present. Alternatively, the audio-out can either be incorporated with a prerecorded sound or replaced by the prerecorded sound.

In some exemplary embodiments, the server is configured for routing control signals obtained from a terminal device 300 of a participant for controlling the pan, zoom, and tilt of a camera 407 associated with a group of that participant.

Referring now to FIG. 5 showing a flowchart diagram of an initiation method of the crowd system in accordance with some exemplary embodiments of the disclosed subject matter.

In FIG. 5, a user logs in and authenticates—501. In box 502, participants are invited. This may involve sending a link to the event. If not already done so then the streaming type may be identified, 503. The outgoing audio may be defined—504 and the incoming audio may be defined 505. Finally streaming may be initiated as the event begins.

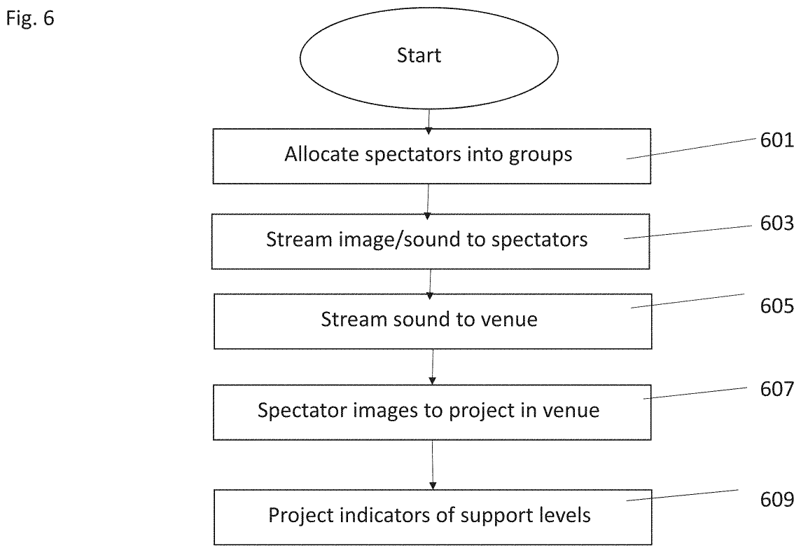

Referring now to FIG. 6, as the event begins the spectators may be allocated into groups for example depending on the locations of their seats 601. Images and sound are streamed 603 to the spectators in group channels so that each group gets a different picture, and sound is streamed 605 from the spectators to the venue, again in group channels so that each loudspeaker in the ground gets a different sound. Sounds within the groups may be equalized, but not between the groups, so that the teams playing may be able to hear who has the more support.

In addition, images may be streamed from the spectators to the venue and projected onto the seating area 607 or to screens. Furthermore, colors or other indicators may be projected 609 onto the seating or screens to indicate the volume of support. Thus the fans of one particular club may be asked to turn their seats to a particular color by shouting louder.

In an embodiment, projection may be onto a screen, to allow the players to see the audience. A bluescreen technique may be used to project images of spectators specifically for the spectators to see, and specific images may be streamed to specific spectators or groups of spectators. Particular user's heads may be projected together with generic bodies, or users may be shown waving their hands. In addition, individual users may be able to project a desired persona onto the venue, for example they may be able to define features of the image that is projected onto their seat such as age, sex, skin color, team uniform or other costumes, scarves, hats, flags and the like. Within the groups, users may be able to agree among themselves using chat, voice etc as provided, about chants or singing etc. For instance a particular team may have a list of songs and the group may agree to start a particular song at a particular time. A timer may be provided that allows the various participants to time themselves into the song. The timer may be visual, counting down digits or may use colors, say traffic light colors. The chat may show the words of the song, in a way that is similar to a karaoke machine. In an embodiment, the system may start playing the song to encourage the spectators to participate. The system may choose a song, or a spectator may choose a song, or the system may provide voting buttons or the like for the group to vote on a song, say starting the song that gets the most votes first. One of the group may be the group leader, having the task of leading the chants or choosing who chooses.

The group or group leader etc. may also be able to decide that at some point in the event, they choose to change the image from individuals to a single individual or to a flag or the like.

The system may provide marketing access, allowing the organizers to market merchandise to the spectators and support advertising in general. The system allows for generalized marketing to the entire audience, or specific targeting of the groups, or seat types, thus particular advertising may be targeted at the VIP users etc. Alternatively or additionally advertising may be targeted at individuals, say in accordance with stored profile information. The system may further enable spectators to participate in online games or place bets on outcomes in the scope of the event.

The entire event may in fact be an online virtual event and voices are added around a virtual stage. In the case of a virtual stage the entire sound is calculated based on positions of the virtual loudspeakers and microphones in relation to the players, musicians etc., and the audience, so that each group hears the sounds as would be experienced by a real spectator sitting at that location in a real venue. As discussed, the spectators may be in groups or may be individuals. Thus spectators and groups of spectators may hear sounds based on their virtual distance from the stage and from other spectators making noise.

The terms “comprises”, “comprising”, “includes”, “including”, and “having” together with their conjugates mean “including but not limited to”. The term “consisting of” has the same meaning as “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this disclosed subject matter may be presented in a range format. It should be understood that the description in range format is merely for convenience and brevity and should not be construed as an inflexible limitation on the scope of the disclosed subject matter. Accordingly, the description of a range should be considered to have specifically disclosed all the possible sub-ranges as well as individual numerical values within that range.

It is appreciated that certain features of the disclosed subject matter, which are, for clarity, described in the context of separate embodiments, may also be provided in combination in a single embodiment and this disclosure is to be construed as if these embodiments are explicitly written out. Conversely, various features of the disclosed subject matter, which are, for brevity, described in the context of a single embodiment, may also be provided separately or in any suitable sub-combination or as suitable in any other described embodiment of the disclosed subject matter and this disclosure is to be construed as if these sub-combinations are explicitly written out. Certain features described in the context of various embodiments are not to be considered essential features of those embodiments, unless the embodiment is inoperative without those elements.

In addition, any priority document(s) of this application is/are hereby incorporated herein by reference in its/their entirety.

1. Artificial live audience system for providing a live spectator experience to player and spectator participants for an event at an event location being a stadium, theater, arena or the like, having a stage area and a seating area, when spectator participants are remotely connected to the event, the system comprising:
a plurality of cameras at locations around said seating area to capture views of said stage area and send respective views to respective spectators;
a plurality of loudspeakers around said seating area, each configured to play sounds gathered from a grouping of said spectators; and
one or more microphones located at said event location, and configured to obtain sounds from said event location, the sounds being sent to each spectator, thereby to provide both said players and said remote spectators with said live spectator experience, wherein at least one of said plurality of cameras has pan, zoom, and tilt capabilities, and respective spectators have controllability to allow said respective spectators to remotely control the pan, zoom, and tilt capabilities of said at least one of said plurality of cameras.

2. The system of claim 1, further comprising at least one communication unit configured to communicate between the event location and respective remotely located spectators, said communication comprising video images and/or sound from the event location to the spectators, and sound from the spectators to the event location.

3. The system of claim 1, wherein the spectators are grouped with respective cameras and respective loudspeakers, wherein the sound from the spectators to the event location comprises sound at each loudspeaker amalgamated from a respective group.

4. The system of claim 3, wherein the spectators are grouped according to an association with seats of respective spectators, such that each group is formed from spectators associated with a contiguous block of seats.

5-6. (canceled)

7. The system as claimed claim 1, wherein the at least one microphone comprises a plurality of microphones, each configured to sense the sound and voices in a vicinity of a respective camera.

8. The system of claim 1, wherein a seat in said seating area is associated with a plurality of spectators.

9. The system as claimed in claim 2, wherein said spectators are grouped to form groups, and wherein said communication unit is configured to provide communication ability between spectators in a given group.

10. The system of claim 9, wherein said grouping is according to an association with seats of respective spectators, such that each group is formed from spectators associated with a contiguous block of seats, said communication thereby being enabled between spectators of neighbouring seats.

11. The system of claim 1, comprising a seat allocation unit for allocating seats to users according to different areas and categories of seats and/or according to respective accompanying privileges.

12. Artificial live audience system for providing a live spectator experience to player and spectator participants for a virtual event, when spectator participants are remotely connected to a virtual event, the system comprising:
a plurality of virtual cameras at locations around said seating area generating views of a virtual stage and sending respective views to respective spectators, wherein at least one of said plurality of cameras has pan, zoom, and tilt capabilities, and respective spectators have controllability to allow said respective spectators to remotely control the pan, zoom, and tilt capabilities of said at least one of said plurality of cameras;
a plurality of virtual loudspeakers around said seating area, each configured to define a spread of sounds to be experienced at said virtual event from said spectators; and
one or more virtual microphones configured to virtually obtain sounds as would be experienced in a real location, the sounds being sent to each spectator, thereby to provide a live spectator experience from said virtual event.
